(19) United States
(12) Patent Application Publication
(10) Pub. No.: US 2025/0293820 A1
(43) Pub. Date: Sep. 18, 2025

(54) SUPPORTING MULTIPLE UE TYPES ON VIRTUAL CELL

(71) Applicant: QUALCOMM Incorporated, San Diego, CA (US)

(72) Inventors: Jing LEI, San Diego, CA (US); Kazuki TAKEDA, Minato-ku (JP)

(21) Appl. No.: 18/608,782

(22) Filed: Mar. 18, 2024

(51) Int. Cl. H04L 5/00; H04W 72/0457; H04W 72/51

(52) U.S. Cl. CPC H04L 5/0041; H04L 5/001; H04L 5/0051; H04W 72/0457; H04W 72/51

(57) ABSTRACT

Method and apparatus for supporting multiple UE types on a virtual cell. The apparatus provides a virtual cell configuration for a virtual cell comprised of an aggregation of a plurality of non-contiguous frequency resources, the virtual cell configuration comprising bandwidth aggregation information and access information of the virtual cell. The apparatus obtains, from a UE, an indication of support for bandwidth aggregation of the virtual cell. The apparatus communicates with the UE on the virtual cell based on the indication of the support for the bandwidth aggregation of the virtual cell. The apparatus may provide a first indication of system information for a first category of UEs. The apparatus may provide a second indication of the system information for a second category of UEs. The apparatus may provide a joint indication of a common system information for a first category of UEs and a second category of UEs.

### TECHNICAL FIELD

The present disclosure relates generally to communication systems, and more particularly, to a configuration for supporting multiple user equipment (UE) types on a virtual cell.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a user equipment (UE). The device may be a processor and/or a modem at a UE or the UE itself. The apparatus receives a virtual cell configuration for a virtual cell comprised of an aggregation of a plurality of non-contiguous frequency resources, the virtual cell configuration comprising bandwidth aggregation information and access information of the virtual cell. The apparatus transmits, to a network entity, an indication of support for bandwidth aggregation of the virtual cell. The apparatus communicates with the network entity on the virtual cell based on the indication of the support for the bandwidth aggregation of the virtual cell.

In an aspect of the disclosure, a method, a computer-readable medium, and an apparatus are provided. The apparatus may be a device at a network node. The device may be a processor and/or a modem at a network node or the network node itself. The apparatus provides a virtual cell configuration for a virtual cell comprised of an aggregation of a plurality of non-contiguous frequency resources, the virtual cell configuration comprising bandwidth aggregation information and access information of the virtual cell. The apparatus obtains, from a user equipment (UE), an indication of support for bandwidth aggregation of the virtual cell. The apparatus communicates with the UE on the virtual cell based on the indication of the support for the bandwidth aggregation of the virtual cell.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of an aggregated bandwidth of a virtual cell.

FIG. 5 is a diagram illustrating an example of a downlink carrier of a virtual cell.

FIG. 6 is a diagram illustrating an example of separate indication of system information (SI) for different UE types.

FIG. 7 is a diagram illustrating an example of a joint indication of SI for different UE types.

FIG. 8A is a diagram illustrating an example of a retuning gap or a measurement gap.

FIG. 8B is a diagram illustrating an example of a state diagram of the different configurations shown in FIG. 8A.

FIG. 9 is a call flow diagram of signaling between a UE and a base station.

FIG. 10 is a flowchart of a method of wireless communication.

FIG. 11 is a flowchart of a method of wireless communication.

FIG. 12 is a diagram illustrating an example of a hardware implementation for an example network entity.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

### DETAILED DESCRIPTION

Wireless communication may continue to target an improved user experience and overall performance. As an example, a 6G communication system may be configured to target an enhanced user experience and an improved overall performance in comparison to a 5G system. However, a new and contiguous frequency spectrum with good coverage may not be available for later deployments. In some aspects, additional low-band and mid-band spectrums may have the potential to re-farm a portion of an ultra-high frequency (UHF) band (e.g., 500-600 MHz) for mobile broadband access. A new upper mid-band spectrum may provide a wider bandwidth (e.g., 100s of MHz) with the objective of supporting comparable coverage as a 5G mid-band (e.g., sub-7 GHZ).

Aspects presented herein help to enable the efficient utilization of the available spectrum, including frequency resources in a lower band such as sub gigahertz resources. In order to overcome restrictions on spectrum reframing or carrier aggregation, a virtual cell may be formed based on flexible spectrum integration (FSI). Carrier aggregation includes a minimum bandwidth for each component carrier, but FSI may be flexible such that a minimum or maximum frequency bandwidth is not specified for each component carrier. For example, the bandwidth of each component frequency resource (e.g., sub-band) of a virtual cell may be less than the minimum BW requirement for primary/secondary component carriers for carrier aggregation (CA), or may be larger than the maximum BW requirement for primary/secondary component carriers of CA. The sub-band of a virtual cell may also be configured in a guard band of two adjacent carriers, or integrated in the spectrum of two adjacent carriers without a guard band in between. In CA, a UE may perform BWP switching across N>1 component carriers, based on a BWP switching delay that depends on the number of component carriers N. For example, the BWP switching delay may increase as the number of aggregated carriers increase.

In wireless systems, such as but not limited to 5G NR, an eMBB UE may report its capabilities in response to a request for CA capabilities from a network entity. In some instances, based on the capability report from the UE, the network may signal the CA-capable UE to add, release, activate, or de-activate SCell(s) after the UE completes an RRC connection establishment with a PCell. In some instances, lower tier UEs (e.g., reduced capacity UEs) may not support CA or dual connectivity (DC), and may not be able to connect to multiple serving cells simultaneously as a CA-capable UE. In a wireless communication system, such as a 6G system, a virtual cell may be formed by FSI having K non-contiguous sub-bands (SBs). If a UE has K or more than K TX/RX chains, then the UE may connect to all SBs on a virtual cell simultaneously, in a similar way as inter-band CA or intra-band non-contiguous CA. However, restricting UEs with less than K TX/RX chains to access the virtual cell reduces spectrum utilization efficiency and co-existence.

Aspects presented herein provide a configuration to enable UEs with different levels of bandwidth aggregation capabilities to co-exist on a virtual cell and make full use of the scattered spectrum. For example, a network may provide to one or more UEs a virtual cell configuration that includes bandwidth aggregation information and access information of a virtual cell, such that the one or more UEs may communicate with the network on the virtual cell based on the one or more UEs supporting bandwidth aggregation of the virtual cell.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

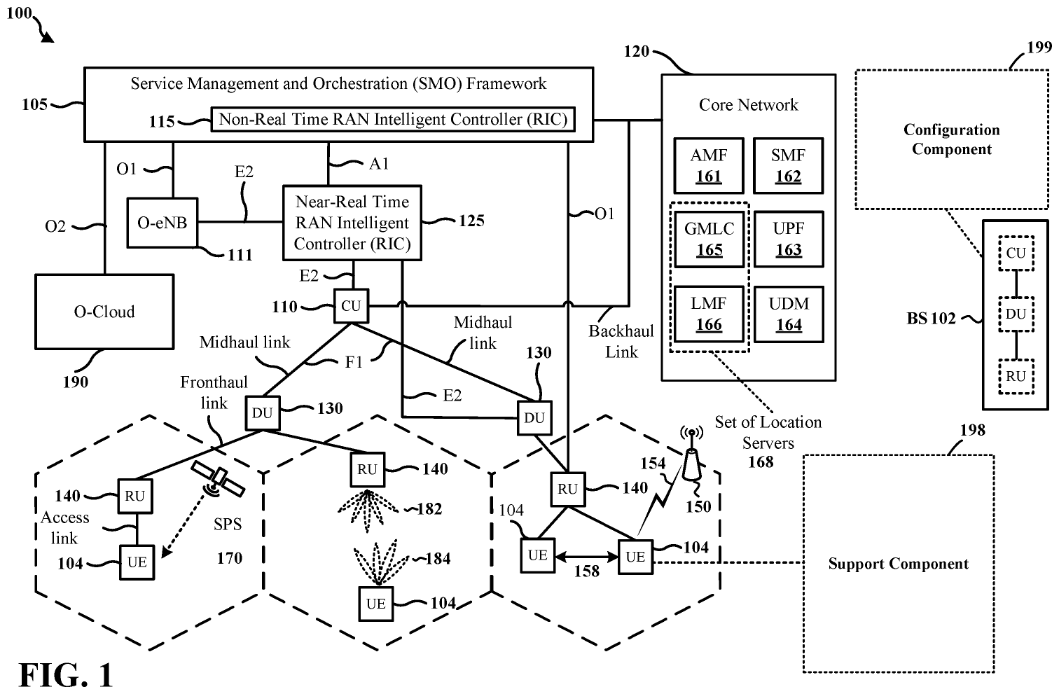

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHZ). Although a portion of FR1 is greater than 6 GHZ, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a support component 198 that may be configured to receive a virtual cell configuration for a virtual cell comprised of an aggregation of a plurality of non-contiguous frequency resources, the virtual cell configuration comprising bandwidth aggregation information and access information of the virtual cell; transmit, to a network entity, an indication of support for bandwidth aggregation of the virtual cell; and communicate with the network entity on the virtual cell based on the indication of the support for the bandwidth aggregation of the virtual cell.

Referring again to FIG. 1, in certain aspects, the base station 102 may include a configuration component 199 that may be configured to provide a virtual cell configuration for a virtual cell comprised of an aggregation of a plurality of non-contiguous frequency resources, the virtual cell configuration comprising bandwidth aggregation information and access information of the virtual cell; obtain, from a UE, an indication of support for bandwidth aggregation of the virtual cell; and communicating with the UE on the virtual cell based on the indication of the support for the bandwidth aggregation of the virtual cell.

Although the following description may be focused on 5G NR, the concepts described herein may be applicable to other similar areas, such as LTE, LTE-A, CDMA, GSM, and other wireless technologies.

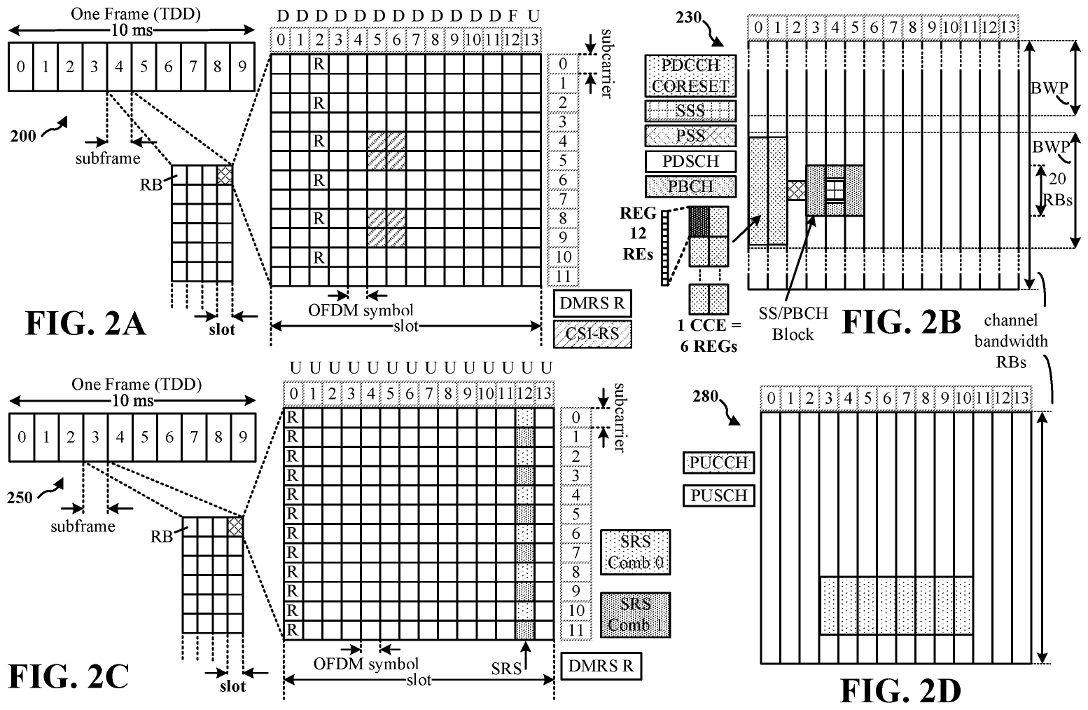

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

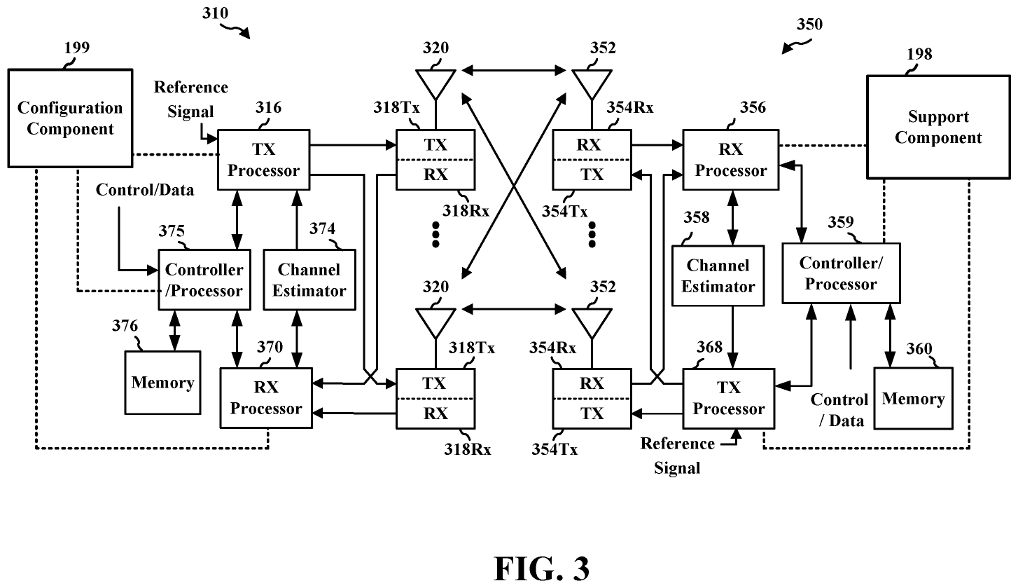

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the support component 198 of FIG. 1.

At least one of the TX processor 316, the RX processor 370, and the controller/processor 375 may be configured to perform aspects in connection with the configuration component 199 of FIG. 1.

Wireless communication may continue to target an improved user experience and overall performance. As an example, a 6G communication system may be configured to target an enhanced user experience and an improved overall performance in comparison to a 5G system. However, a new and contiguous frequency spectrum with good coverage may not be available for later deployments. In some aspects, additional low-band and mid-band spectrums may have the potential to re-farm a portion of an ultra-high frequency (UHF) band (e.g., 500-600 MHz) for mobile broadband access. A new upper mid-band spectrum may provide a wider bandwidth (e.g., 100 s of MHz) with the objective of supporting comparable coverage as a 5G mid-band (e.g., sub-7 GHz).

Aspects presented herein help to enable the efficient utilization of the available spectrum, including frequency resources in a lower band such as sub gigahertz resources. In order to overcome restrictions on spectrum reframing or carrier aggregation, a virtual cell may be formed based on flexible spectrum integration (FSI). Carrier aggregation includes a minimum bandwidth for each component carrier, but FSI may be flexible such that a minimum or maximum frequency bandwidth is not specified for each component carrier. For example, the bandwidth of each component frequency resource (e.g., sub-band) of a virtual cell may be less than the minimum BW requirement for primary/secondary component carriers for carrier aggregation (CA), or may be larger than the maximum BW requirement for primary/secondary component carriers of CA. The sub-band of a virtual cell may also be configured in a guard band of two adjacent carriers, or integrated in the spectrum of two adjacent carriers without a guard band in between. In CA, a UE may perform BWP switching across N>1 component carriers, based on a BWP switching delay that depends on the number of component carriers N. For example, the BWP switching delay may increase as the number of aggregated carriers increase.

In wireless systems, such as but not limited to 5G NR, an eMBB UE may report its capabilities with regard to carrier aggregation (CA) (e.g., indicating support for one or more capabilities such as supportedBandCombination, supportedBasebandProcessing Combination, or ca-BandwidthClassDL/ca-BandwidthClassUL) in response to a request for CA capabilities (e.g., UECapabilityEnquiry) from a network entity. In some instances, based on the capability report from the UE, the network may signal the CA-capable UE to add, release, activate, or de-activate SCell(s) after the UE completes an RRC connection establishment with a PCell. In some instances, lower tier UEs (e.g., reduced capacity UEs) may not support CA or dual connectivity (DC), and may not be able to connect to multiple serving cells simultaneously as a CA-capable UE.

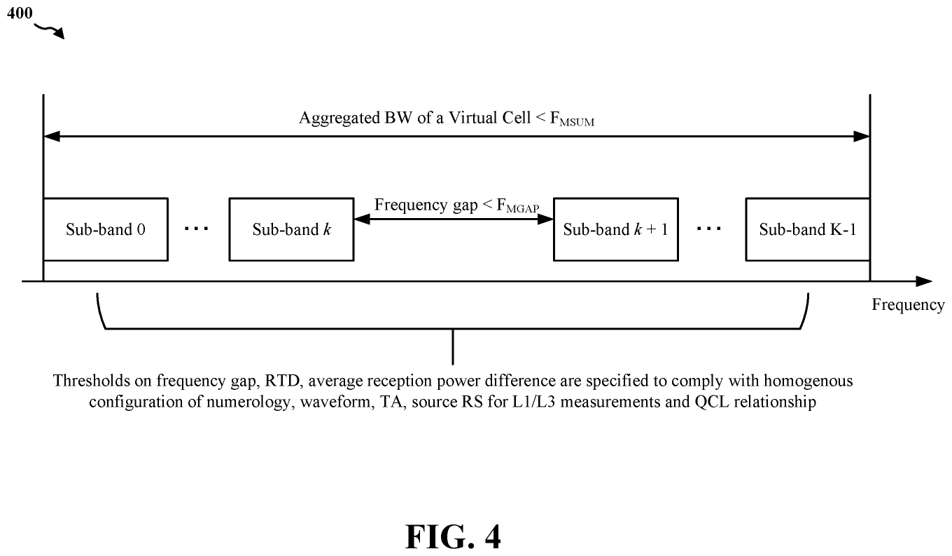

In a wireless communication system, such as a 6G system, a virtual cell may be formed by FSI having K non-contiguous sub-bands (SBs), as shown for example in diagram 400 of FIG. 4. If a UE has K or more than K TX/RX chains, then the UE may connect to all SBs on a virtual cell simultaneously, in a similar way as inter-band CA or intra-band non-contiguous CA. However, restricting UEs with less than K TX/RX chains to access the virtual cell reduces spectrum utilization efficiency and co-existence.

Aspects presented herein provide a configuration to enable UEs with different levels of bandwidth aggregation capabilities to co-exist on a virtual cell and make full use of the scattered spectrum. For example, a network may provide to one or more UEs a virtual cell configuration that includes bandwidth aggregation information and access information of a virtual cell, such that the one or more UEs may communicate with the network on the virtual cell based on the one or more UEs supporting bandwidth aggregation of the virtual cell. At least one advantage of the disclosure is that UEs having different levels of bandwidth aggregation may communicate with the network on a virtual cell and efficiently utilize the scattered spectrum of the virtual cell.

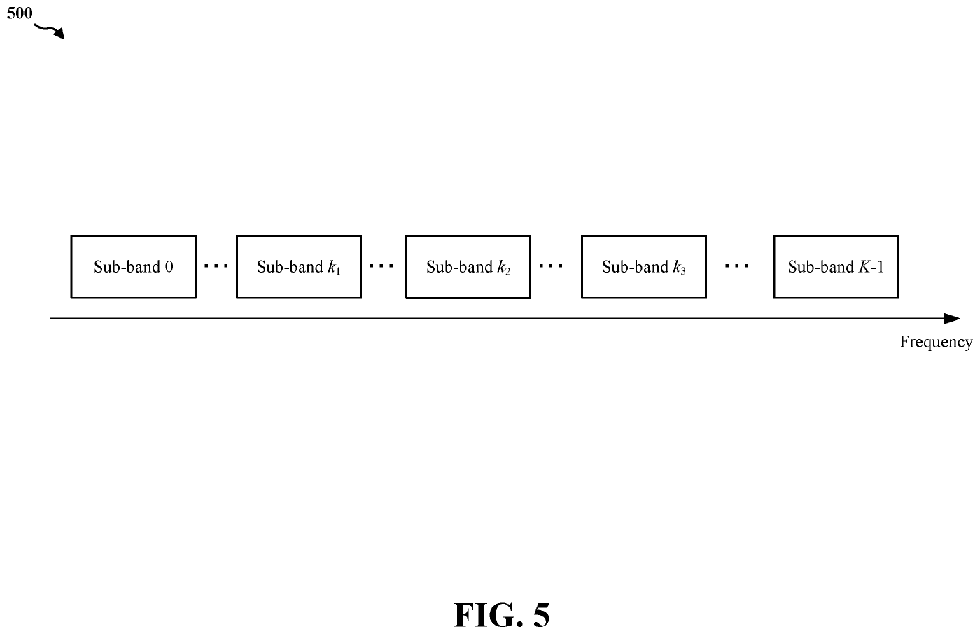

In some instances, bandwidth aggregation information and access information of a virtual cell may be provided to UEs from the network. For example, a network entity may provide the bandwidth aggregation information and the access information of the virtual cell via a broadcast (e.g., in a MIB or SIB), groupcast, or in dedicated RRC signaling directed to the UE. The bandwidth aggregation information may include the location, bandwidth, and/or a duplex mode of each SB associated with the virtual cell. In some instances, the access information may be cell specific (e.g., applicable to all SBs of a virtual cell), SB specific, or SB group specific (e.g., applicable to a group of SBs). In some instances, the access information may include access control information (e.g., access categories/identities barred or not barred from the virtual cell/SB/SB group). The initial access information may be associated with different UE types or network slices supported by the activated SB or SB group, such as if the SSB and system information (SI) are transmitted by the virtual cell on one or multiple SBs. For example, as shown in diagram 500 of FIG. 5, a downlink carrier of a virtual cell may include K>1 SBs, such that a premium UE (e.g., enhanced capacity or higher capacity UE) with wide bandwidth aggregation capabilities may access any SB of the virtual cell, and connect to K SBs at the same time. However, mid-tier or low-tier UEs may not be capable of aggregating the K SBs at the same time, and may be configured to access a subset of the SBs, for example as indexed by {0, k₁, k₂, k₃, . . . }. As discussed herein, a premium UE may be configured to connect with all SBs of a virtual cell at the same time, whereas mid-tier or low-tier UEs (e.g., reduced capacity UEs) may have reduced capabilities in comparison to the premium UE, such that the mid-tier or low-tier UEs may not be configured to connect with all the SBs of the virtual cell at the same time. Instead, mid-tier or low-tier UEs may be configured to access a subset of the SBs of the virtual cell.

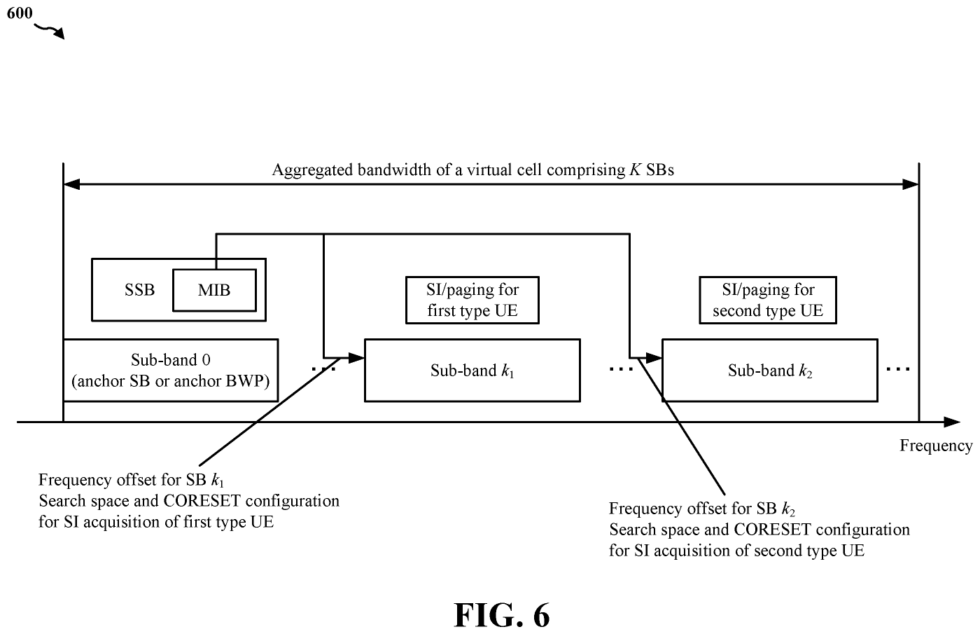

In some instances, a separate indication of SI may be provided by the network for different types of UEs. The network may provide SSB on an anchor SB or anchor BWP, and the center frequency of the SSB may be specified by synchronization raster (e.g., which may be referred to as a sync raster). In some instances, the network may allow two different UE types, for example a first type UE and a second type UE, to access the virtual cell. In such instances, the first type UE may have an advanced capability to aggregate all SBs in a virtual cell, and can connect to all SBs at the same time, while the second type UE can aggregate a subset of SBs, including the anchor SB, but may not connect to all SBs of the virtual cell at the same time. In instances where the network allows the first type UE and the second type UE to access the virtual cell, the search space and CORESET configuration for SI acquisition may be indicated to different UE types separately, for example, by different fields in MIB as shown for example in diagram 600 of FIG. 6. The different fields within the MIB may be associated or corresponding to the different UE types.

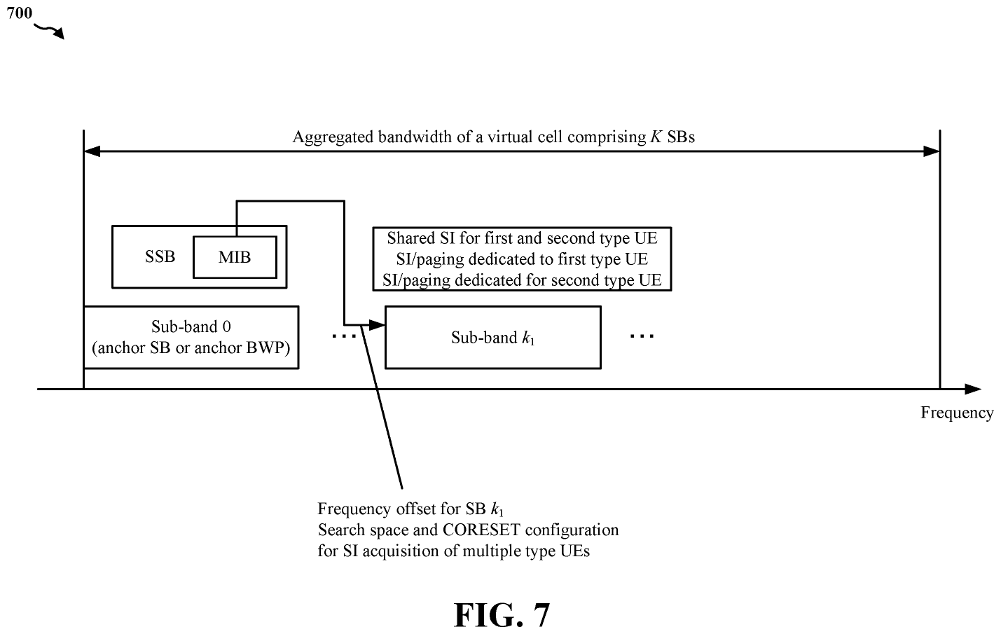

In some instances, a joint indication of SI may be provided by the network for different types of UEs. A search space and CORESET configuration for SI acquisition may be jointly indicated to different UE types, for example, by a shared field in MIB as shown for example in diagram 700 of FIG. 7. In addition to common SI shared by multiple UE types, dedicated SI and paging resource configurations may be indicated separately to the different UE types that are configured to access the virtual cell. In instances where a common SI and dedicated SI are multiplexed on the same channel, they may be mapped to different information elements (e.g., second type UE may not parse/process the dedicated SI for first type UE, and vice versa). If paging resources (paging early indication or wake up signal, if supported) for different UE types are configured on the same SB, the associated channels (e.g., PDCCH, PDSCH) and RS may have the same or different configurations. In some aspects, separate configurations for paging resources, or paging early indication or wake up signal, a first type UE may not need to monitor for or decode an SI update, paging messages, or paging early indication or wake up signal, that are dedicated to a second type UE, and vice versa. For example, the first type UE can skip monitoring for or decoding of the SI update, paging messages, paging early indication, and/or wake-up signal that are for the second type UE. At least one advantage of the disclosure is to reduce power consumption by enabling some UEs to reduce monitoring for and/or decoding SI updates or paging messages. The reduced monitoring and decoding helps the UE to increase power savings.

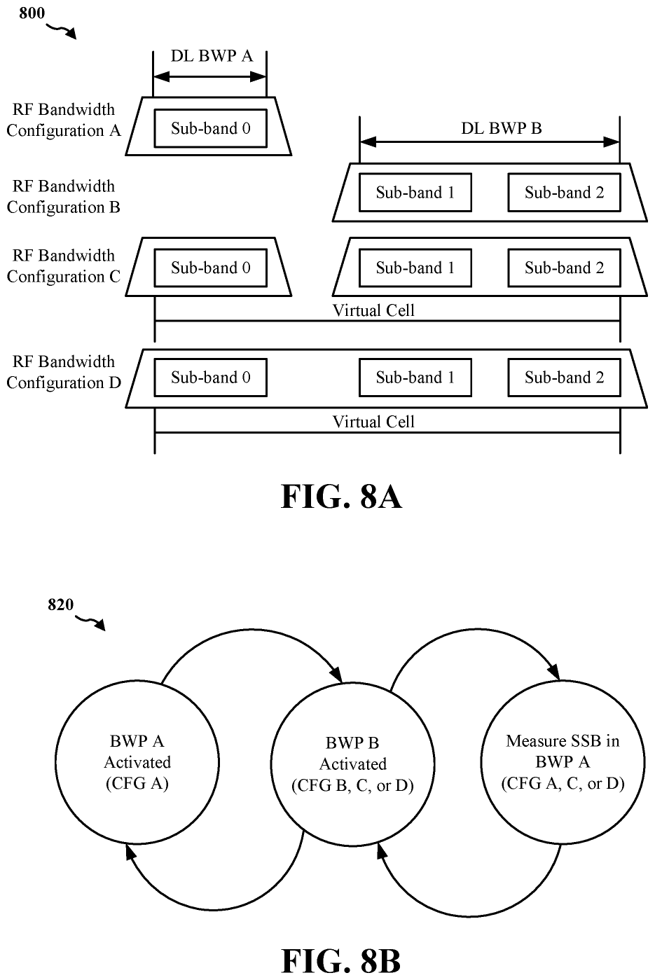

In some instances, to enable bandwidth adaptation and RS measurements outside an active BWP on virtual cell, different procedures may be supported by UE types associated with different CA or bandwidth capabilities. For example, with reference to diagram 800 of FIG. 8A and diagram 820 of FIG. 8B, a retuning gap and/or a measurement gap may be specified for a first type and/or a second type UE. In some instances, the second type UE may have a limited bandwidth aggregation capability (e.g., a maximum carrier bandwidth (CBW) of second type UE<aggregated bandwidth of the virtual cell). The second type UE may utilize a retuning gap in order to measure RS outside of its active SB. With reference to FIGS. 8A and 8B, the second type UE may be operating on a downlink active BWP B, which may include SB1 and SB2, but does not include SB0. In the example of FIG. 8A, it is assumed that SSB is transmitted on SB0 only. If the second type UE is to measure SB0 when operating on the downlink BWP B, the network may configure a retuning gap and a measurement gap to allow for the measurement of RS within SB0. In such instances, the second type UE suspends communication on the downlink BWP B to perform the RS measurement within SB0.

In some instances, the first type UE (e.g., maximum CBW of first type UE≥aggregated BW of a virtual cell) having advanced bandwidth capability, which may open up its bandwidth to include all the SBs together, may either indicate an enhanced UE capability for gap-less BWP switching and/or gap-less RS measurements outside active DL BWP. In some instances, the first type UE may request a smaller retuning gap for BW adaptation and measurements. Through gap-assisted bandwidth adaptation, mid or low tier UEs (e.g., a second type UE) may access all SBs of a virtual cell, and the network may reduce the RS overhead and save energy (e.g., SSB not required to be transmitted on all SBs of a virtual cell).

Diagram 820 of FIG. 8B provides an example of a state diagram of the different configurations shown in FIG. 8A. FIG. 8A includes four different configuration examples (e.g., RF BW Configuration A, RF BW Configuration B, RF BW Configuration C, and RF BW Configuration D). In some instances, if a UE is to operate within the downlink BWP B, the UE could either open its bandwidth as much as the two SBs within downlink BWP B or the UE could open its bandwidth wider than its BWP (e.g., RF BW Configuration B, RF BW Configuration C, and RF BW Configuration D), such that the UE may operate using any of RF BW Configuration B, RF BW Configuration C, and RF BW Configuration D. The RF BW configurations that may be supported by the UE may be based on the UE capabilities. In some instances, if the UE wants to do an SSB measurement on BWP A when camped on BWP B, then the UE may utilize RF BW Configuration A, RF BW Configuration C, or RF BW Configuration D to perform such measurements. In some instances, when a UE transmits between different states, some UEs may utilize a gap while some UEs may not need a gap or may utilize a smaller gap.

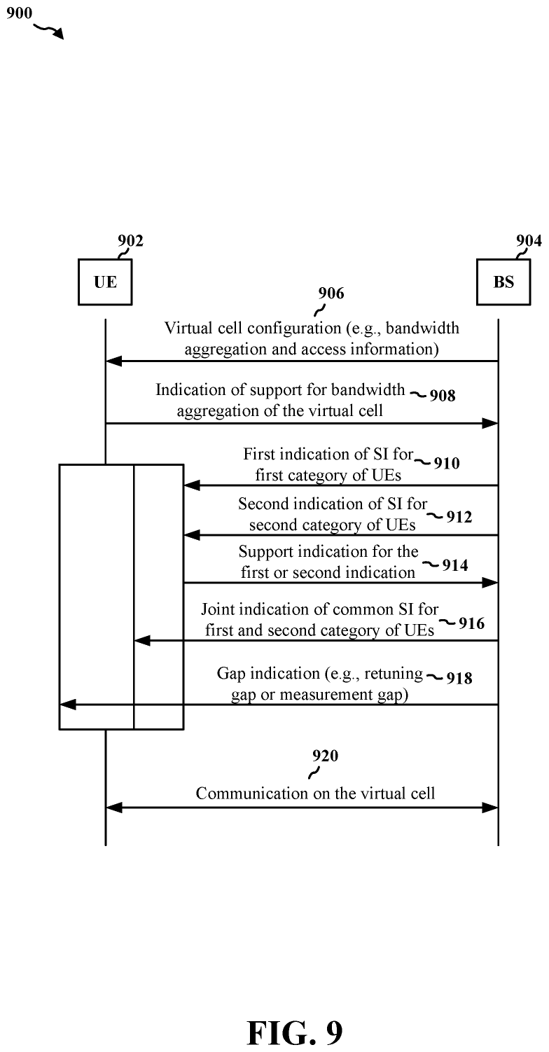

FIG. 9 is a call flow diagram 900 of signaling between a UE 902 and a base station 904. The base station 904 may be configured to provide at least one cell. The UE 902 may be configured to communicate with the base station 904. For example, in the context of FIG. 1, the base station 904 may correspond to base station 102 and the UE 902 may correspond to at least UE 104. In another example, in the context of FIG. 3, the base station 904 may correspond to base station 310 and the UE 902 may correspond to UE 350.

At 906, the base station 904 may provide a virtual cell configuration for a virtual cell comprised of an aggregation of a plurality of non-contiguous frequency resources. The virtual cell may include any of the aspects described in connection with FIGS. 4-8B, for example. The base station 904 may provide the virtual cell configuration for the virtual cell to the UE 902. The UE 902 may receive the virtual cell configuration for the virtual cell from the base station 904. The virtual cell configuration may include bandwidth aggregation information and access information of the virtual cell. In some aspects, the virtual cell may include a logical cell configured by flexible spectrum integration. In some aspects, the bandwidth aggregation information may include one or more of a location, a bandwidth, or a duplex mode of each subband associated with the virtual cell. In some aspects, the access information may correspond to one or more subbands associated with the virtual cell or a subband group associated with the virtual cell. Each subband of the virtual cell may include one or more component carriers or a portion of a component carrier. In some aspects, the access information may include access control information for accessing the virtual cell, initial access information associated with one or more categories of UEs, or initial access information associated with network slices supported by activated subbands or activated subband groups.

At 908, the UE 902 may transmit an indication of support for bandwidth aggregation of the virtual cell. The UE 902 may transmit, to the base station 904, the indication of the support for the bandwidth aggregation of the virtual cell. The base station 904 may obtain the indication of the support for the bandwidth aggregation of the virtual cell from the UE 902.

At 910, the base station 904 may provide a first indication of system information for a first category of UEs. In some aspects, the first category of UEs may have an advanced capability to aggregate all subbands in a virtual cell. In such instances, the first category of UEs may be configured to connect with all subbands of the virtual cell. In some aspects, the UE 902 may comprise the first category of UE.

At 912, the base station 904 may provide a second indication of the system information for a second category of UEs. In some aspects, the second category of UEs may have a reduced capacity than that of the first category of UEs and may aggregate a small or reduced amount of subbands than that of the first category of UEs, and may not be configured to connect with all the subbands of the virtual cell at the same time. In such instances, the second category of UEs may be configured to connect with a subset of subbands of the virtual cell. In some aspects, the UE 902 may comprise the second category of UE.

At 914, the UE 902 may transmit a support indication for the first indication or the second indication. The UE 902 may transmit, to the base station 904, the support indication for the first indication or the second indication. The base station 904 may obtain the support indication for the first indication or the second indication from the UE 902.

At 916, the base station 904 may provide a joint indication of a common system information. The base station 904 may provide the joint indication of the common system information for the first category of UEs and the second category of UEs to the UE 902. The UE 902 may receive the joint indication of the common system information for the first category of UEs and the second category of UEs from the base station 904. In some aspects, a dedicated system information and paging resource configurations may be provided separately to the first category of UEs and the second category of UEs. The UE 902 may transmit an acknowledgement or an indication indicating that the UE 902 is the first category or the second category of UEs in response to the joint indication of the common system information.

At 918, the base station 904 may provide a gap indication of a retuning gap or a measurement gap. The base station 904 may provide the gap indication of the retuning gap or the measurement gap to allow for reference signal measurements for a BWP outside of an active BWP to the UE 902. The UE 902 may receive the gap indication of the retuning gap or the measurement gap to allow for reference signal measurements for a BWP outside of an active BWP from the base station 904. In some aspects, the retuning gap and/or measurement gap may be specified for the second category of UE having a limited or reduced bandwidth aggregation capability (e.g., maximum CBW of the second category of UE is less than an aggregated bandwidth of a virtual cell).

At 920, the UE 902 may transmit a UE capability indication indicating support for gapless BWP switching or gapless reference signal measurements for a BWP outside of an active BWP. The UE 902 may transmit the UE capability indication indicating the support for the gapless BWP switching or the gapless reference signal measurements for the BWP outside of the active BWP to the base station 904. The base station 904 may obtain the UE capability indication indicating the support for the gapless BWP switching or the gapless reference signal measurements for the BWP outside of the active BWP from the UE 902. In some aspects, the first category of UE (e.g., maximum CBW of the first category of UE≥an aggregated bandwidth of a virtual cell) may either indicate an enhanced UE capability for gapless BWP switching and gapless reference signal measurements outside an active downlink BWP. In some aspects, the first category of UE may request a smaller retuning gape for bandwidth adaptation and measurements.

At 922, the UE 902 may communicating with the base station 904 on the virtual cell. The communicating with the base station on the virtual cell may be based on the indication of the support for the bandwidth aggregation of the virtual cell.

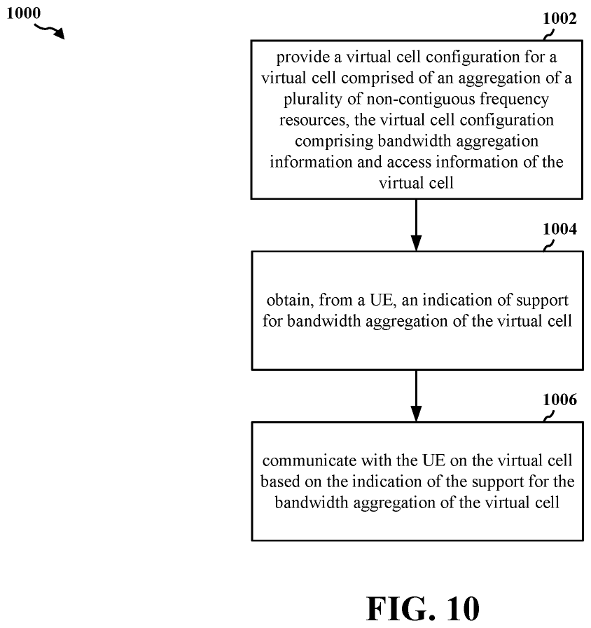

FIG. 10 is a flowchart 1000 of a method of wireless communication. The method may be performed by a base station (e.g., the base station 102; the network entity 1202, 1502). One or more of the illustrated operations may be omitted, transposed, or contemporaneous. The method may configure a network entity to support multiple UE types on a virtual cell.

At 1002, the network entity may provide a virtual cell configuration for a virtual cell comprised of an aggregation of a plurality of non-contiguous frequency resources. The virtual cell may include any of the aspects described in connection with FIGS. 4-8B, for example. For example, 1002 may be performed by configuration component 199 of network entity 1202. The virtual cell configuration may include bandwidth aggregation information and access information of the virtual cell. In some aspects, the virtual cell may include a logical cell configured by flexible spectrum integration. In some aspects, the bandwidth aggregation information may include one or more of a location, a bandwidth, or a duplex mode of each subband associated with the virtual cell. In some aspects, the access information may correspond to one or more subbands associated with the virtual cell or a subband group associated with the virtual cell. Each subband of the virtual cell may include one or more component carriers or a portion of a component carrier. In some aspects, the access information may include access control information for accessing the virtual cell, initial access information associated with one or more categories of UEs, or initial access information associated with network slices supported by activated subbands or activated subband groups.

At 1004, the network entity may obtain an indication of support for bandwidth aggregation of the virtual cell. For example, 1004 may be performed by configuration component 199 of network entity 1202. The network entity may obtain, from a UE, the indication of the support for the bandwidth aggregation of the virtual cell.

At 1006, the network entity may communicate with the UE on the virtual cell. For example, 1006 may be performed by configuration component 199 of network entity 1202. The network entity may communicate with the UE on the virtual cell based on the indication of the support for the bandwidth aggregation of the virtual cell.

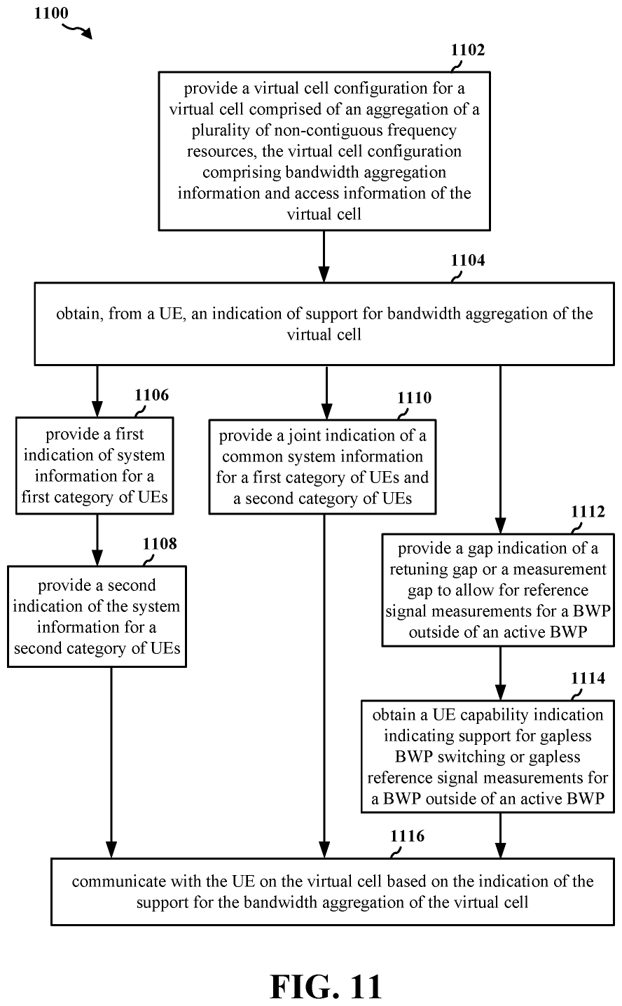

FIG. 11 is a flowchart 1100 of a method of wireless communication. The method may be performed by a base station (e.g., the base station 102; the network entity 1202, 1502). One or more of the illustrated operations may be omitted, transposed, or contemporaneous. The method may configure a network entity to support multiple UE types on a virtual cell.

At 1102, the network entity may provide a virtual cell configuration for a virtual cell comprised of an aggregation of a plurality of non-contiguous frequency resources. The virtual cell may include any of the aspects described in connection with FIGS. 4-8B, for example. For example, 1102 may be performed by configuration component 199 of network entity 1202. The virtual cell configuration may include bandwidth aggregation information and access information of the virtual cell. In some aspects, the virtual cell may include a logical cell configured by flexible spectrum integration. In some aspects, the bandwidth aggregation information may include one or more of a location, a bandwidth, or a duplex mode of each subband associated with the virtual cell. In some aspects, the access information may correspond to one or more subbands associated with the virtual cell or a subband group associated with the virtual cell. Each subband of the virtual cell may include one or more component carriers or a portion of a component carrier. In some aspects, the access information may include access control information for accessing the virtual cell, initial access information associated with one or more categories of UEs, or initial access information associated with network slices supported by activated subbands or activated subband groups.

At 1104, the network entity may obtain an indication of support for bandwidth aggregation of the virtual cell. For example, 1004 may be performed by configuration component 199 of network entity 1202. The network entity may obtain, from a UE, the indication of the support for the bandwidth aggregation of the virtual cell.

At 1106, the network entity may provide a first indication of system information for a first category of UEs. For example, 1106 may be performed by configuration component 199 of network entity 1202. In some aspects, the first category of UEs may have an advanced capability to aggregate all subbands in a virtual cell. In such instances, the first category of UEs may be configured to connect with all subbands of the virtual cell.

At 1108, the network entity may provide a second indication of the system information for a second category of UEs. For example, 1108 may be performed by configuration component 199 of network entity 1202. In some aspects, the second category of UEs may have a reduced capacity than that of the first category of UEs and may aggregate a small or reduced amount of subbands than that of the first category of UEs, and may not be configured to connect with all the subbands of the virtual cell at the same time. In such instances, the second category of UEs may be configured to connect with a subset of subbands of the virtual cell.

At 1110, the network entity may provide a joint indication of a common system information. For example, 1110 may be performed by configuration component 199 of network entity 1202. The network entity may provide the joint indication of the common system information for the first category of UEs and the second category of UEs. In some aspects, a dedicated system information and paging resource configurations may be provided separately to the first category of UEs and the second category of UEs.

At 1112, the network entity may provide a gap indication of a retuning gap or a measurement gap. For example, 1112 may be performed by configuration component 199 of network entity 1202. The network entity may provide the gap indication of the retuning gap or the measurement gap to allow for reference signal measurements for a BWP outside of an active BWP. In some aspects, the retuning gap and/or measurement gap may be specified for the second category of UE having a limited or reduced bandwidth aggregation capability (e.g., maximum CBW of the second category of UE is less than an aggregated bandwidth of a virtual cell).

At 1114, the network entity may obtain a UE capability indication indicating support for gapless BWP switching or gapless reference signal measurements for a BWP outside of an active BWP. For example, 1114 may be performed by configuration component 199 of network entity 1202. In some aspects, the first category of UE (e.g., maximum CBW of the first category of UE≥an aggregated bandwidth of a virtual cell) may either indicate an enhanced UE capability for gapless BWP switching and gapless reference signal measurements outside an active downlink BWP. In some aspects, the first category of UE may request a smaller retuning gape for bandwidth adaptation and measurements.

At 1116, the network entity may communicate with the UE on the virtual cell. For example, 1116 may be performed by configuration component 199 of network entity 1202. The network entity may communicate with the UE on the virtual cell based on the indication of the support for the bandwidth aggregation of the virtual cell.

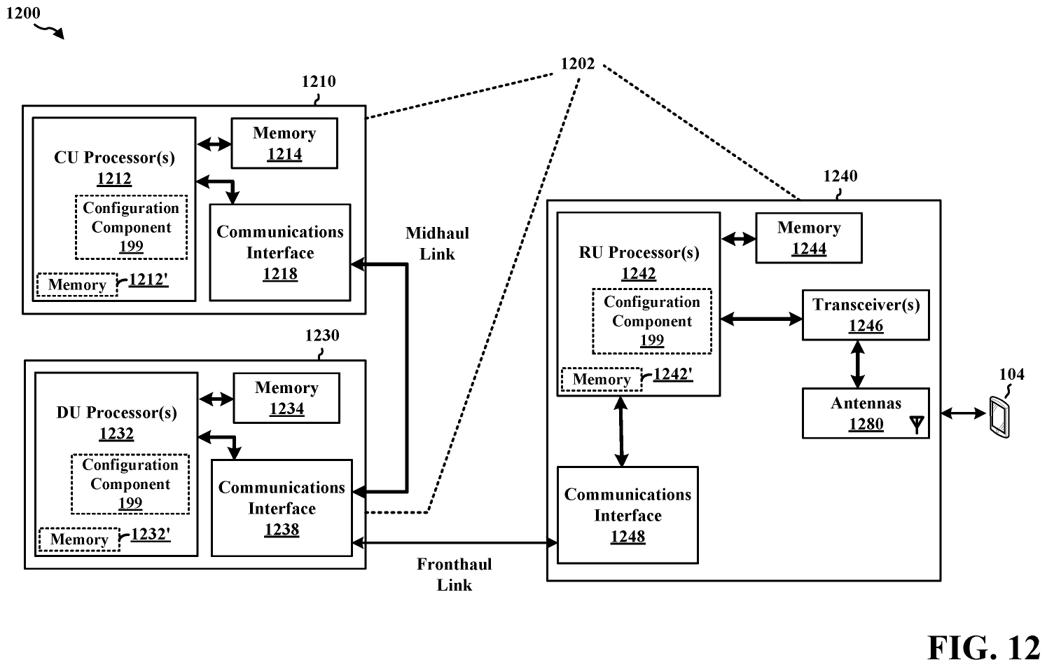

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide a virtual cell configuration for a virtual cell comprised of an aggregation of a plurality of non-contiguous frequency resources, the virtual cell configuration comprising bandwidth aggregation information and access information of the virtual cell; obtain, from a UE, an indication of support for bandwidth aggregation of the virtual cell; and communicate with the UE on the virtual cell based on the indication of the support for the bandwidth aggregation of the virtual cell. The component 199, or the network entity, may be further configured to perform any of the aspects described in connection with the flowcharts in FIG. 10 or 11 and/or performed by the base station in the communication flow in FIG. 9. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for providing a virtual cell configuration for a virtual cell comprised of an aggregation of a plurality of non-contiguous frequency resources, the virtual cell configuration comprising bandwidth aggregation information and access information of the virtual cell. The network entity includes means for obtaining, from a UE, an indication of support for bandwidth aggregation of the virtual cell. The network entity includes means for communicating with the UE on the virtual cell based on the indication of the support for the bandwidth aggregation of the virtual cell. The network entity further includes means for providing a first indication of system information for a first category of UEs. The network entity further includes means for providing a second indication of the system information for a second category of UEs. The network entity further includes means for providing a joint indication of a common system information for a first category of UEs and a second category of UEs. The network entity further includes means for providing a gap indication of a retuning gap or a measurement gap to allow for reference signal measurements for a BWP outside of an active BWP. The network entity further includes means for obtaining a UE capability indication indicating support for gapless BWP switching or gapless reference signal measurements for a BWP outside of an active BWP. The network entity may further include means for performing any of the aspects described in connection with the flowcharts in FIG. 10 or 11 and/or performed by the base station in the communication flow in FIG. 9. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

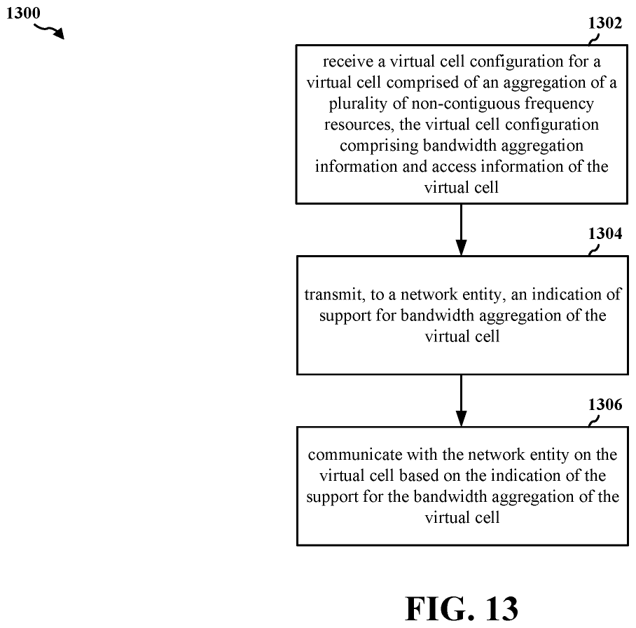

FIG. 13 is a flowchart 1300 of a method of wireless communication. The method may be performed by a UE (e.g., the UE 104; the apparatus 1504). One or more of the illustrated operations may be omitted, transposed, or contemporaneous. The method may allow for multiple UE types to be supported on a virtual cell of a network entity.

At 1302, the UE may receive a virtual cell configuration for a virtual cell comprised of an aggregation of a plurality of non-contiguous frequency resources. The virtual cell may include any of the aspects described in connection with FIGS. 4-8B, for example. For example, 1302 may be performed by support component 198 of apparatus 1504. The virtual cell configuration may include bandwidth aggregation information and access information of the virtual cell. In some aspects, the virtual cell may include a logical cell configured by flexible spectrum integration. In some aspects, the bandwidth aggregation information may include one or more of a location, a bandwidth, or a duplex mode of each subband associated with the virtual cell. In some aspects, the access information may correspond to one or more subbands associated with the virtual cell or a subband group associated with the virtual cell. Each subband of the virtual cell may include one or more component carriers or a portion of a component carrier. In some aspects, the access information may include access control information for accessing the virtual cell, initial access information associated with one or more categories of UEs, or initial access information associated with network slices supported by activated subbands or activated subband groups.

At 1304, the UE may transmit an indication of support for bandwidth aggregation of the virtual cell. For example, 1304 may be performed by support component 198 of apparatus 1504. The UE may transmit, to a network entity, the indication of the support for the bandwidth aggregation of the virtual cell.

At 1306, the UE may communicating with the network entity on the virtual cell. For example, 1306 may be performed by support component 198 of apparatus 1504. The communicating with the network entity on the virtual cell based on the indication of the support for the bandwidth aggregation of the virtual cell.

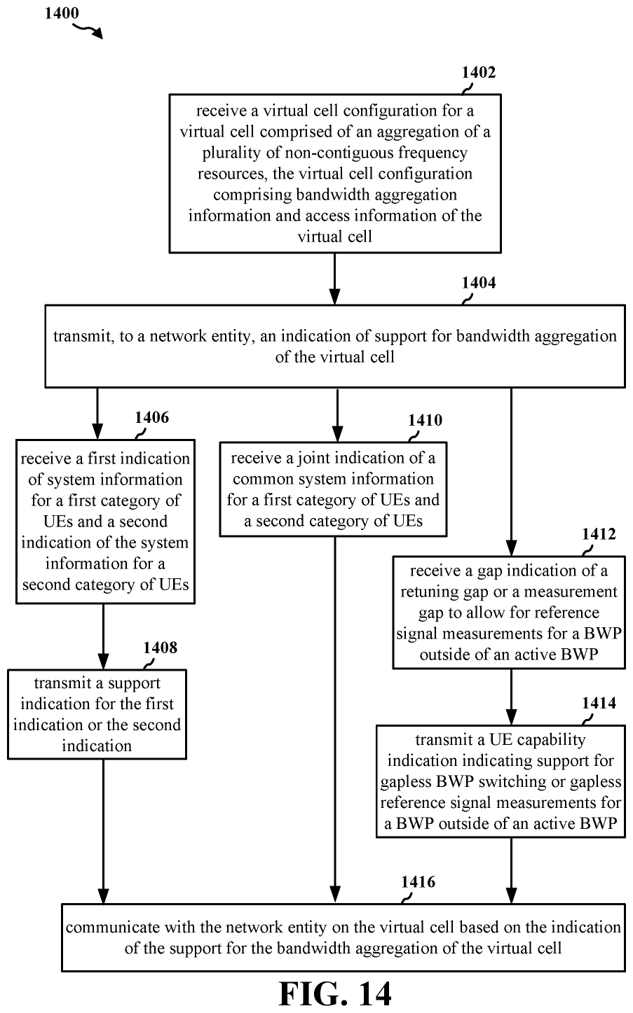

FIG. 14 is a flowchart 1400 of a method of wireless communication. The method may be performed by a UE (e.g., the UE 104; the apparatus 1504). One or more of the illustrated operations may be omitted, transposed, or contemporaneous. The method may allow for multiple UE types to be supported on a virtual cell of a network entity.

At 1402, the UE may receive a virtual cell configuration for a virtual cell comprised of an aggregation of a plurality of non-contiguous frequency resources. The virtual cell may include any of the aspects described in connection with FIGS. 4-8B, for example. For example, 1402 may be performed by support component 198 of apparatus 1504. The virtual cell configuration may include bandwidth aggregation information and access information of the virtual cell. In some aspects, the virtual cell may include a logical cell configured by flexible spectrum integration. In some aspects, the bandwidth aggregation information may include one or more of a location, a bandwidth, or a duplex mode of each subband associated with the virtual cell. In some aspects, the access information may correspond to one or more subbands associated with the virtual cell or a subband group associated with the virtual cell. Each subband of the virtual cell may include one or more component carriers or a portion of a component carrier. In some aspects, the access information may include access control information for accessing the virtual cell, initial access information associated with one or more categories of UEs, or initial access information associated with network slices supported by activated subbands or activated subband groups.

At 1404, the UE may transmit an indication of support for bandwidth aggregation of the virtual cell. For example, 1404 may be performed by support component 198 of apparatus 1504. The UE may transmit, to a network entity, the indication of the support for the bandwidth aggregation of the virtual cell.

At 1406, the UE may receive a first indication of system information for a first category of UEs and a second indication of the system information for a second category of UEs. For example, 1406 may be performed by support component 198 of apparatus 1504. In some aspects, the first category of UEs are configured to connect with all subbands of the virtual cell. In some aspects, the second category of UEs are configured to connect with a subset of subbands of the virtual cell.

At 1408, the UE may transmit a support indication for the first indication or the second indication. For example, 1408 may be performed by support component 198 of apparatus 1504. The UE may transmit, to the network entity, the support indication for the first indication or the second indication.

At 1410, the UE may receive a joint indication of a common system information. For example, 1410 may be performed by support component 198 of apparatus 1504. The may receive the joint indication of the common system information for the first category of UEs and the second category of UEs. In some aspects, a dedicated system information and paging resource configurations may be provided separately to the first category of UEs and the second category of UEs.

At 1412, the UE may receive a gap indication of a retuning gap or a measurement gap. For example, 1412 may be performed by support component 198 of apparatus 1504. The UE may receive the gap indication of the retuning gap or the measurement gap to allow for reference signal measurements for a bandwidth part (BWP) outside of an active BWP. In some aspects, the retuning gap and/or measurement gap may be specified for the second category of UE having a limited or reduced bandwidth aggregation capability (e.g., maximum CBW of the second category of UE is less than an aggregated bandwidth of a virtual cell).

At 1414, the UE may transmit a UE capability indication indicating support for gapless BWP switching or gapless reference signal measurements for a BWP outside of an active BWP. For example, 1414 may be performed by support component 198 of apparatus 1504. In some aspects, the first category of UE (e.g., maximum CBW of the first category of UE≥an aggregated bandwidth of a virtual cell) may either indicate an enhanced UE capability for gapless BWP switching and gapless reference signal measurements outside an active downlink BWP. In some aspects, the first category of UE may request a smaller retuning gape for bandwidth adaptation and measurements.

At 1416, the UE may communicating with the network entity on the virtual cell. For example, 1416 may be performed by support component 198 of apparatus 1504. The communicating with the network entity on the virtual cell based on the indication of the support for the bandwidth aggregation of the virtual cell.

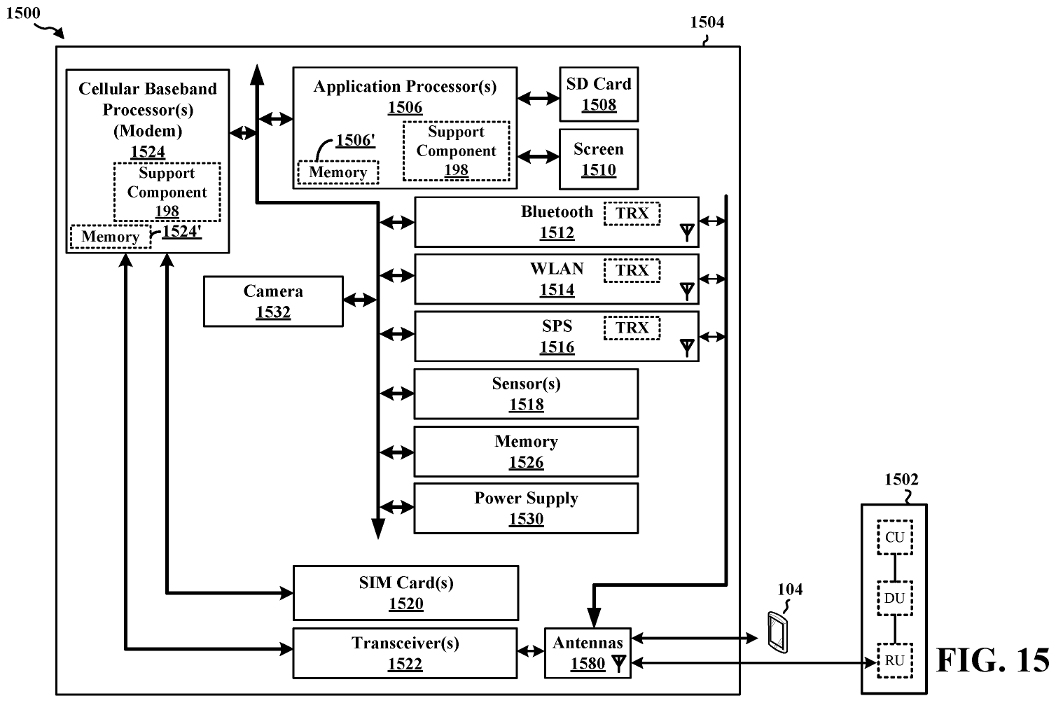

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1006 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to receive a virtual cell configuration for a virtual cell comprised of an aggregation of a plurality of non-contiguous frequency resources, the virtual cell configuration comprising bandwidth aggregation information and access information of the virtual cell; transmit, to a network entity, an indication of support for bandwidth aggregation of the virtual cell; and communicate with the network entity on the virtual cell based on the indication of the support for the bandwidth aggregation of the virtual cell. The component 198, or the apparatus, may be further configured to perform any of the aspects described in connection with the flowcharts in FIG. 13 or 14 and/or performed by the UE in the communication flow in FIG. 9. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving a virtual cell configuration for a virtual cell comprised of an aggregation of a plurality of non-contiguous frequency resources, the virtual cell configuration comprising bandwidth aggregation information and access information of the virtual cell. The apparatus includes means for transmitting, to a network entity, an indication of support for bandwidth aggregation of the virtual cell. The apparatus includes means for communicating with the network entity on the virtual cell based on the indication of the support for the bandwidth aggregation of the virtual cell. The apparatus further includes means for receiving a first indication of system information for a first category of UEs and a second indication of the system information for a second category of UEs. The apparatus further includes means for transmitting a support indication for the first indication or the second indication. The apparatus further includes means for receiving a joint indication of a common system information for a first category of UEs and a second category of UEs. The apparatus further includes means for receiving a gap indication of a retuning gap or a measurement gap to allow for reference signal measurements for a BWP outside of an active BWP. The apparatus further includes means for transmitting a UE capability indication indicating support for gapless BWP switching or gapless reference signal measurements for a BWP outside of an active BWP. The apparatus may further include means for performing any of the aspects described in connection with the flowcharts in FIG. 13 or 14 and/or performed by the UE in the communication flow in FIG. 9. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network entity comprising providing a virtual cell configuration for a virtual cell comprised of an aggregation of a plurality of non-contiguous frequency resources, the virtual cell configuration comprising bandwidth aggregation information and access information of the virtual cell; obtaining, from a UE, an indication of support for bandwidth aggregation of the virtual cell; and communicating with the UE on the virtual cell based on the indication of the support for the bandwidth aggregation of the virtual cell.

Aspect 2 is the method of aspect 1, further includes that the virtual cell comprises a logical cell configured by flexible spectrum integration.

Aspect 3 is the method of any of aspects 1 and 2, further includes that the bandwidth aggregation information comprises one or more of a location, a bandwidth, or a duplex mode of each subband associated with the virtual cell.

Aspect 4 is the method of any of aspects 1-3, further includes that the access information corresponds to one or more subbands associated with the virtual cell or a subband group associated with the virtual cell, wherein each subband of the virtual cell comprises one or more component carriers or a portion of a component carrier.

Aspect 5 is the method of any of aspects 1-4, further includes that the access information comprises access control information for accessing the virtual cell, initial access information associated with one or more categories of UEs, or initial access information associated with network slices supported by activated subbands or activated subband groups.

Aspect 6 is the method of any of aspects 1-5, further including providing a first indication of system information for a first category of UEs; and providing a second indication of the system information for a second category of UEs.

Aspect 7 is the method of any of aspects 1-6, further includes that the first category of UEs are configured to connect with all subbands of the virtual cell, wherein the second category of UEs are configured to connect with a subset of subbands of the virtual cell.

Aspect 8 is the method of any of aspects 1-7, further including providing a joint indication of a common system information for a first category of UEs and a second category of UEs.

Aspect 9 is the method of any of aspects 1-8, further includes that a dedicated system information and paging resource configurations are provided separately to the first category of UEs and the second category of UEs.

Aspect 10 is the method of any of aspects 1-9, further including providing a gap indication of a retuning gap or a measurement gap to allow for reference signal measurements for a BWP outside of an active BWP.

Aspect 11 is the method of any of aspects 1-10, further including obtaining a UE capability indication indicating support for gapless BWP switching or gapless reference signal measurements for a BWP outside of an active BWP.

Aspect 12 is an apparatus for wireless communication at a network entity including at least one processor coupled to a memory and at least one transceiver, the at least one processor configured to implement any of aspects 1-11.

Aspect 13 is an apparatus for wireless communication at a network entity including means for implementing any of aspects 1-11.

Aspect 14 is a computer-readable medium storing computer executable code, where the code when executed by a processor causes the processor to implement any of aspects 1-11.

Aspect 15 is a method of wireless communication at a UE comprising receiving a virtual cell configuration for a virtual cell comprised of an aggregation of a plurality of non-contiguous frequency resources, the virtual cell configuration comprising bandwidth aggregation information and access information of the virtual cell; transmitting, to a network entity, an indication of support for bandwidth aggregation of the virtual cell; and communicating with the network entity on the virtual cell based on the indication of the support for the bandwidth aggregation of the virtual cell.

Aspect 16 is the method of aspect 15, further includes that the virtual cell comprises a logical cell configured by flexible spectrum integration.

Aspect 17 is the method of any of aspects 15 and 16, further includes that the bandwidth aggregation information comprises one or more of a location, a bandwidth, or a duplex mode of each subband associated with the virtual cell.

Aspect 18 is the method of any of aspects 15-17, further includes that the access information corresponds to one or more subbands associated with the virtual cell or a subband group associated with the virtual cell, wherein each subband of the virtual cell comprises one or more component carriers or a portion of a component carrier.

Aspect 19 is the method of any of aspects 15-18, further includes that the access information comprises access control information for accessing the virtual cell, initial access information associated with one or more categories of UEs, or initial access information associated with network slices supported by activated subbands or activated subband groups.

Aspect 20 is the method of any of aspects 15-19, further including receiving a first indication of system information for a first category of UEs and a second indication of the system information for a second category of UEs; and transmitting a support indication for the first indication or the second indication.

Aspect 21 is the method of any of aspects 15-20, further includes that the first category of UEs are configured to connect with all subbands of the virtual cell, wherein the second category of UEs are configured to connect with a subset of subbands of the virtual cell.

Aspect 22 is the method of any of aspects 15-21, further including receiving a joint indication of a common system information for a first category of UEs and a second category of UEs.

Aspect 23 is the method of any of aspects 15-22, further includes that a dedicated system information and paging resource configurations are provided separately to the first category of UEs and the second category of UEs.

Aspect 24 is the method of any of aspects 15-23, further including receiving a gap indication of a retuning gap or a measurement gap to allow for reference signal measurements for a BWP outside of an active BWP.

Aspect 25 is the method of any of aspects 15-24, further including transmitting a UE capability indication indicating support for gapless BWP switching or gapless reference signal measurements for a BWP outside of an active BWP.

Aspect 26 is an apparatus for wireless communication at a UE including at least one processor coupled to a memory and at least one transceiver, the at least one processor configured to implement any of aspects 15-25.

Aspect 27 is an apparatus for wireless communication at a UE including means for implementing any of aspects 15-25.

Aspect 28 is a computer-readable medium storing computer executable code, where the code when executed by a processor causes the processor to implement any of aspects 15-25.

What is claimed is:

1. An apparatus for wireless communication at a network entity, comprising:
at least one memory; and
at least one processor coupled to the at least one memory and, based at least in part on information stored in the at least one memory, the at least one processor, individually or in any combination, is configured to cause the apparatus to:
provide a virtual cell configuration for a virtual cell comprised of an aggregation of a plurality of non-contiguous frequency resources, the virtual cell configuration comprising bandwidth aggregation information and access information of the virtual cell;
obtain, from a user equipment (UE), an indication of support for bandwidth aggregation of the virtual cell; and
communicate with the UE on the virtual cell based on the indication of the support for the bandwidth aggregation of the virtual cell.

2. The apparatus of claim 1, further comprising a transceiver coupled to the at least one processor, the transceiver being configured to:
provide the virtual cell configuration for the virtual cell comprised of the aggregation of the plurality of non-contiguous frequency resources, the virtual cell configuration comprising the bandwidth aggregation information and the access information of the virtual cell;
obtain, from the UE, the indication of support for the bandwidth aggregation of the virtual cell; and
communicate with the UE on the virtual cell based on the indication of the support for the bandwidth aggregation of the virtual cell.

3. The apparatus of claim 1, wherein the virtual cell comprises a logical cell configured by flexible spectrum integration.

4. The apparatus of claim 1, wherein the bandwidth aggregation information comprises one or more of a location, a bandwidth, or a duplex mode of each subband associated with the virtual cell.

5. The apparatus of claim 1, wherein the access information corresponds to one or more subbands associated with the virtual cell or a subband group associated with the virtual cell, wherein each subband of the virtual cell comprises one or more component carriers or a portion of a component carrier.

6. The apparatus of claim 5, wherein the access information comprises:
access control information for accessing the virtual cell,
initial access information associated with one or more categories of user equipments (UEs), or
initial access information associated with network slices supported by activated subbands or activated subband groups.

7. The apparatus of claim 1, wherein the at least one processor is configured to:
provide a first indication of system information for a first category of user equipments (UEs); and
provide a second indication of the system information for a second category of UEs.

8. The apparatus of claim 7, wherein the first category of UEs are configured to connect with all subbands of the virtual cell, wherein the second category of UEs are configured to connect with a subset of subbands of the virtual cell.

9. The apparatus of claim 1, wherein the at least one processor is configured to:
provide a joint indication of a common system information for a first category of user equipments (UEs) and a second category of UEs.

10. The apparatus of claim 9, wherein a dedicated system information and paging resource configurations are provided separately to the first category of UEs and the second category of UEs.

11. The apparatus of claim 1, wherein the at least one processor is configured to:
provide a gap indication of a retuning gap or a measurement gap to allow for reference signal measurements for a bandwidth part (BWP) outside of an active BWP.

12. The apparatus of claim 1, wherein the at least one processor is configured to:
obtain a UE capability indication indicating support for gapless bandwidth part (BWP) switching or gapless reference signal measurements for a BWP outside of an active BWP.

13. A method of wireless communication at a network entity, comprising:
providing a virtual cell configuration for a virtual cell comprised of an aggregation of a plurality of non-contiguous frequency resources, the virtual cell configuration comprising bandwidth aggregation information and access information of the virtual cell;
obtaining, from a user equipment (UE), an indication of support for bandwidth aggregation of the virtual cell; and
communicating with the UE on the virtual cell based on the indication of the support for the bandwidth aggregation of the virtual cell.

14. The method of claim 13, wherein the bandwidth aggregation information comprises one or more of a location, a bandwidth, or a duplex mode of each subband associated with the virtual cell, wherein the access information corresponds to one or more subbands associated with the virtual cell or a subband group associated with the virtual cell, wherein each subband of the virtual cell comprises one or more component carriers or a portion of a component carrier.

15. The method of claim 13, further comprising:
providing a first indication of system information for a first category of user equipments (UEs); and
providing a second indication of the system information for a second category of UEs.

16. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the apparatus to:
receive a virtual cell configuration for a virtual cell comprised of an aggregation of a plurality of non-contiguous frequency resources, the virtual cell configuration comprising bandwidth aggregation information and access information of the virtual cell;
transmit, to a network entity, an indication of support for bandwidth aggregation of the virtual cell; and
communicate with the network entity on the virtual cell based on the indication of the support for the bandwidth aggregation of the virtual cell.

17. The apparatus of claim 16, further comprising a transceiver coupled to the at least one processor, the transceiver being configured to:
receive the virtual cell configuration for the virtual cell comprised of the aggregation of the plurality of non-contiguous frequency resources, the virtual cell configuration comprising the bandwidth aggregation information and the access information of the virtual cell;
transmit, to the network entity, the indication of support for the bandwidth aggregation of the virtual cell; and
communicate with the network entity on the virtual cell based on the indication of the support for the bandwidth aggregation of the virtual cell.

18. The apparatus of claim 16, wherein the virtual cell comprises a logical cell configured by flexible spectrum integration.

19. The apparatus of claim 16, wherein the bandwidth aggregation information comprises one or more of a location, a bandwidth, or a duplex mode of each subband associated with the virtual cell.

20. The apparatus of claim 16, wherein the access information corresponds to one or more subbands associated with the virtual cell or a subband group associated with the virtual cell, wherein each subband of the virtual cell comprises one or more component carriers or a portion of a component carrier.

21. The apparatus of claim 20, wherein the access information comprises:
access control information for accessing the virtual cell,
initial access information associated with one or more categories of user equipments (UEs), or
initial access information associated with network slices supported by activated subbands or activated subband groups.

22. The apparatus of claim 16, wherein the at least one processor is configured to:
receive a first indication of system information for a first category of UEs and a second indication of the system information for a second category of UEs; and
transmit a support indication for the first indication or the second indication.

23. The apparatus of claim 22, wherein the first category of UEs are configured to connect with all subbands of the virtual cell, wherein the second category of UEs are configured to connect with a subset of subbands of the virtual cell.

24. The apparatus of claim 16, wherein the at least one processor is configured to:
receive a joint indication of a common system information for a first category of UEs and a second category of UEs.

25. The apparatus of claim 24, wherein a dedicated system information and paging resource configurations are provided separately to the first category of UEs and the second category of UEs.

26. The apparatus of claim 16, wherein the at least one processor is configured to:
receive a gap indication of a retuning gap or a measurement gap to allow for reference signal measurements for a bandwidth part (BWP) outside of an active BWP.

27. The apparatus of claim 16, wherein the at least one processor is configured to:
transmit a UE capability indication indicating support for gapless bandwidth part (BWP) switching or gapless reference signal measurements for a BWP outside of an active BWP.

28. A method of wireless communication at a user equipment (UE), comprising:
receiving a virtual cell configuration for a virtual cell comprised of an aggregation of a plurality of non-contiguous frequency resources, the virtual cell configuration comprising bandwidth aggregation information and access information of the virtual cell;
transmitting, to a network entity, an indication of support for bandwidth aggregation of the virtual cell; and
communicating with the network entity on the virtual cell based on the indication of the support for the bandwidth aggregation of the virtual cell.

29. The method of claim 28, wherein the bandwidth aggregation information comprises one or more of a location, a bandwidth, or a duplex mode of each subband associated with the virtual cell, wherein the access information corresponds to one or more subbands associated with the virtual cell or a subband group associated with the virtual cell, wherein each subband of the virtual cell comprises one or more component carriers or a portion of a component carrier.

30. The method of claim 28, further comprising:
receiving a first indication of system information for a first category of UEs and a second indication of the system information for a second category of UEs; and
transmitting a support indication for the first indication or the second indication.
